(19) United States
(12) Patent Application Publication
(10) Pub. No.: US 2020/0103710 A1
(43) Pub. Date: Apr. 2, 2020

(54) LIQUID CRYSTAL DISPLAY

(71) Applicant: Samsung Display Co., Ltd., Yongin-si (KR)

(72) Inventors: Heung Shik PARK, Seoul (KR); Kyeong Jong KIM, Suwon-si (KR); Ki Chul SHIN, Seongnam-si (KR); Ho Kil OH, Seoul (KR); Jae-Soo JANG, Suwon-si (KR)

(21) Appl. No.: 16/416,790

(22) Filed: May 20, 2019

(30) Foreign Application Priority Data
Oct. 2, 2018 (KR) 10-2018-0117479

(51) Int. Cl. G02F 1/13363; G02F 1/1335

(52) U.S. Cl. CPC G02F 1/133634; G02F 1/133528; G02F 2413/12; G02F 2413/11; G02F 2413/02; G02F 2413/14

(57) ABSTRACT

A display panel includes a liquid crystal layer, a negative-type C plate compensation layer, and a B plate compensation layer or an A plate compensation layer, and retardation values provided by the liquid crystal layer and the compensation layers are set to allow light perpendicular to a lateral transmittance angle, which is an angle formed by a transmissive axis of the upper polarizer with respect to a transmissive axis of the lower polarizer when viewed from a specific position on a lateral side, to be transmitted to the upper polarizer when the display panel displays a black color.

This application claims priority to Korean Patent Application No. 10-2018-0117479, filed on Oct. 2, 2018, and all the benefits accruing therefrom under 35 U.S.C. 119, the content of which in its entirety is herein incorporated by reference.

### BACKGROUND

### (a) Field

The disclosure relates to a liquid crystal display.

### (b) Description of the Related Art

A liquid crystal display may include two field generating electrodes, a liquid crystal layer, a color filter, and a polarization layer. Light generated by a light source passes through the liquid crystal layer, the color filter and the polarization layer, and reaches a viewer. According to an electric field generated by a field generating electrode, retardation provided by the liquid crystal layer to the light passing through the same changes, and according to a polarization characteristic of the light having reached the polarization layer, the light is blocked or transmitted to express a certain gray color.

### SUMMARY

In a liquid crystal display, a transmittance characteristic of a polarizer thereof may become different when the viewer views from the front and from the side.

### Exemplary embodiment of the invention relate to a liquid crystal display with improved contrast ratio (“CR”) at all sides by using a compensation film.

An exemplary embodiment of the invention provides a liquid crystal display including: a display panel including an upper panel, a lower panel, and a liquid crystal layer disposed between the upper panel and the lower panel; and a backlight unit which provides light to the display panel. In such an embodiment, the upper panel includes an upper polarizer, the lower panel includes a B plate compensation layer and a lower polarizer, one of the upper panel and the lower panel further includes a negative-type C plate compensation layer, and retardation values provided by the liquid crystal layer, the B plate compensation layer and the negative-type C plate compensation layer are set to allow light perpendicular to a lateral transmittance angle, which is an angle of a transmissive axis of the upper polarizer with respect to a transmissive axis of the lower polarizer when viewed from a specific position on a lateral side, to be transmitted to the upper polarizer when displaying a black color.

In an exemplary embodiment, the negative-type C plate compensation layer may have an out-of-plane retardation value (Rₜₕ) in a range of about 80 nanometers (nm) to about 260 nm.

In an exemplary embodiment, the B plate compensation layer may have an optically biaxial characteristic, and the B plate compensation layer may have an in-plane retardation value (Rₒ) in a range of about 50 nm to about 100 nm, and an out-of-plane retardation value (Rₜₕ) in a range of about 80 nm to about 190 nm.

In an exemplary embodiment, the liquid crystal layer may include liquid crystal molecules, the liquid crystal molecules may be vertically aligned when an electric field is not applied thereto, and the liquid crystal layer may provide retardation in a range of about 240 nm to about 400 nm to the light provided by the backlight unit.

In an exemplary embodiment, the out-of-plane retardation value (Rₜₕ) of the negative-type C plate compensation layer and the out-of-plane retardation value (Rₜₕ) of the B plate compensation layer may satisfy the following condition: 180 nm≤Rₜₕ of B plate+Rₜₕ of C plate≤460 nm, where Rₜₕ of B plate denotes the out-of-plane retardation value (Rₜₕ) of the B plate compensation layer, and Rₜₕ of C plate denotes the out-of-plane retardation value (Rₜₕ) of the negative-type C plate compensation layer.

In an exemplary embodiment, the negative-type C plate compensation layer may have the out-of-plane retardation value (Rₜₕ) of about 180 nm, the B plate compensation layer may have an in-plane retardation value(Rₒ) of about 75 nm and the out-of-plane retardation value (Rₜₕ) of about 135 nm, and the liquid crystal layer may provide retardation of about 320 nm to the light provided by the backlight unit.

In an exemplary embodiment, the specific position of the lateral side may be in a region where high lateral light leakage occurrence is observed.

In an exemplary embodiment, the upper panel may include the negative-type C plate compensation layer, and the negative-type C plate compensation layer may be disposed on an inner surface of the upper panel.

In an exemplary embodiment, the lower panel may include the negative-type C plate compensation layer, and the negative-type C plate compensation layer may be disposed on an inner surface of the lower panel.

In an exemplary embodiment, the negative-type C plate compensation layer may be formed by coating a material for providing retardation.

Another exemplary embodiment of the invention provides a liquid crystal display including: a display panel including an upper panel, a lower panel, and a liquid crystal layer disposed between the upper panel and the lower panel; and a backlight unit which provides light to the display panel. In such an embodiment, the upper panel includes an upper polarizer, the lower panel includes an A plate compensation layer and a lower polarizer, one of the upper panel and the lower panel further includes a negative-type C plate compensation layer, and retardation values provided by the liquid crystal layer, the A plate compensation layer and the negative-type C plate compensation layer are set to allow light perpendicular to a lateral transmittance angle, which is an angle of a transmissive axis of the upper polarizer with respect to the transmissive axis of the lower polarizer when viewed from a specific position on a lateral side, to be transmitted to the upper polarizer when displaying a black color.

In an exemplary embodiment, the negative-type C plate compensation layer may have an out-of-plane retardation value (Rₜₕ) in a range of about 90 nm to about 450 nm.

In an exemplary embodiment, the A plate compensation layer may have an optically uniaxial characteristic, and an in-plane retardation value (Rₒ) of the A plate compensation layer may be in a range of about 70 nm to about 180 nm.

In an exemplary embodiment, the liquid crystal layer may include liquid crystal molecules, the liquid crystal molecules may be vertically arranged when an electric field is not applied thereto, and the liquid crystal layer may provide retardation in a range of about 240 nm to about 400 nm to the light provided by the backlight unit.

In an exemplary embodiment, an out-of-plane retardation value (Rₜₕ) of the negative-type C plate compensation layer and an out-of-plane retardation value (Rₜₕ) of the A plate compensation layer may satisfy the following condition: 180 nm≤value Rₜₕ of A plate+value Rₜₕ of C plate≤460, where Rₜₕ of A plate denotes the out-of-plane retardation value (Rₜₕ) of the A plate compensation layer, and Rₜₕ of C plate denotes the out-of-plane retardation value (Rₜₕ) of the negative-type C plate compensation layer.

In an exemplary embodiment, the A plate compensation layer may have the out-of-plane retardation value (Rₜₕ) of about 125 nm, and the liquid crystal layer may provide retardation of about 320 nm to the light provided by the backlight unit.

In an exemplary embodiment, the specific position of the lateral side may be in a region where high light leakage occurrence is observed.

In an exemplary embodiment, the upper panel may include the negative-type C plate compensation layer, and the negative-type C plate compensation layer may be disposed on an inner surface of the upper panel.

In an exemplary embodiment, the lower panel may include the negative-type C plate compensation layer, and the negative-type C plate compensation layer may be disposed on an inner surface of the lower panel.

In an exemplary embodiment, the negative-type C plate compensation layer may be formed by coating a material for providing retardation.

According to exemplary embodiments, the compensation characteristic is controlled with respect to the angle of the transmissive axis of the polarizer viewed on a lateral side to correct the light leakage that occurs on the lateral side and thereby realize the high CR at all sides.

### BRIEF DESCRIPTION OF THE DRAWINGS

The above and other features of the invention will become more apparent by describing in detail exemplary embodiments thereof with reference to the attached drawings, in which:

FIG. 1 shows a schematic diagram of a liquid crystal display according to an exemplary embodiment;

FIG. 2 shows a transmissive axis of a polarizer on a front side and a lateral side;

FIG. 3 shows spherical coordinates for a light polarization characteristic with respect to a position in a liquid crystal display;

FIG. 4 sequentially shows changes of polarization of light according to an exemplary embodiment of FIG. 1;

FIG. 5 and FIG. 6 show graphs of relative black luminance for a value Rₜₕ of a compensation film;

FIG. 7 shows a schematic diagram of a liquid crystal display according to an alternative exemplary embodiment;

FIG. 8 sequentially shows changes of polarization of light according to an exemplary embodiment of FIG. 7;

FIG. 9 shows a table of contrast ratios (“CR”) at all sides according to an exemplary embodiment of FIG. 1 and an alternative exemplary embodiment of FIG. 7;

FIG. 10 shows a schematic diagram of a liquid crystal display according to another alternative exemplary embodiment;

FIG. 11 shows changes of polarization of light according to an exemplary embodiment of FIG. 10; and

FIG. 12 shows a schematic diagram of a liquid crystal display according to another alternative exemplary embodiment.

### DETAILED DESCRIPTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention.

The drawings and description are to be regarded as illustrative in nature and not restrictive, and like reference numerals designate like elements throughout the specification.

The size and thickness of each configuration shown in the drawings are arbitrarily shown for better understanding and ease of description, and the invention is not limited thereto. In the drawings, the thickness of layers, films, panels, regions, etc., are exaggerated for clarity. For better understanding and ease of description, the thicknesses of some layers and areas are exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system).

The terminology used herein is for the purpose of describing particular embodiments only and is not intended to be limiting of the inventive concept. As used herein, the singular forms “a,” “an,” and “the” are intended to include the plural forms, including “at least one,” unless the content clearly indicates otherwise. “Or” means “and/or.” “At least one of A and B” means “A and/or B.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The phrase “on a plane” means viewing the object portion from the top, and the phrase “on a cross-section” means viewing a cross-section of which the object portion is vertically cut from the side.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, exemplary embodiments will now be described in detail with reference to accompanying drawings.

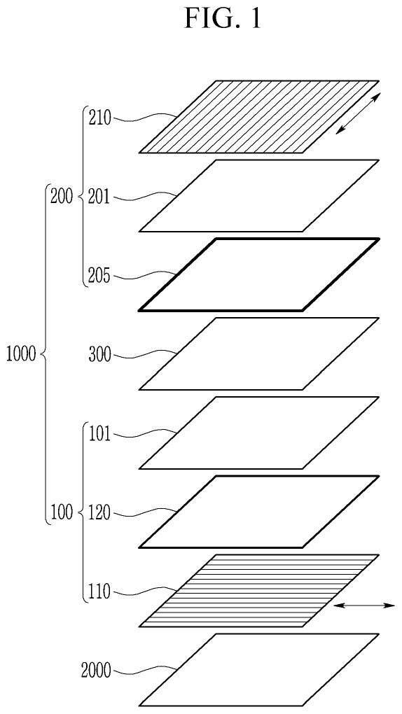

FIG. 1 shows a schematic diagram of a liquid crystal display according to an exemplary embodiment.

An exemplary embodiment of the liquid crystal display includes a display panel 1000 and a backlight unit 2000.

In such an embodiment, the backlight unit 2000 provides light to the display panel 1000. The backlight unit 2000 may provide white light or light of a specific color. In an exemplary embodiment, where the backlight unit 2000 provides white light, the display panel 1000 displays a color by using a color filter to provide light of a specific wavelength. In an alternative exemplary embodiment where the backlight unit 2000 provides the light of the specific color, a color filter corresponding to the specific color may be omitted, and a color conversion layer may be included to display another color different from the specific color. Hereinafter, for convenience of description, exemplary embodiments where the backlight unit 2000 provides white light to the display panel 1000 will be described in detail.

In such an embodiment, the backlight unit 2000 may include a white light emitting diode (“LED”) to provide white light. In such an embodiment, the white LED may be realized by adding a yellow fluorescent material such as Y3Al5O12 (“YAG”) to a front side of an LED for emitting blue light to emit white light.

Light emitted by the backlight unit 2000 may input at an angle that is substantially vertical with respect to a bottom side of the display panel 1000. In such an embodiment, the backlight unit 2000 may include at least one of various optical sheets such as a prism sheet, a diffuser sheet, a reflection sheet, or a luminance improvement film to improve light efficiency.

The display panel 1000 may include a lower panel 100, an upper panel 200, and a liquid crystal layer 300 disposed therebetween.

In an exemplary embodiment, the lower panel 100 includes a lower substrate 101, a B plate compensation layer 120 attached to a rear side thereof, and a lower polarizer 110. A thin film transistor (“TFT”) (not shown) and a pixel electrode (not shown) may be disposed inside the lower substrate 101 of the lower panel 100. The lower substrate 101 will also be referred to as a TFT substrate.

In an exemplary embodiment, the lower substrate 101 includes a transparent substrate including or made of a transparent material such as glass, and a gate line and a data line extend in different directions on a top side of the transparent substrate. In such an embodiment, a TFT including a control terminal and an input terminal connected to a gate line and a data line is disposed on the transparent substrate, and a pixel electrode is connected to an output terminal of the TFT. The TFT applies a voltage to the pixel electrode by a signal applied to the gate line and the data line.

The lower polarizer 110 and the B plate compensation layer 120 are attached to a bottom side (or an outer surface) of the lower substrate 101. In an exemplary embodiment, the B plate compensation layer 120 is attached to the bottom side of the lower substrate 101, and the lower polarizer 110 is attached below the lower substrate 101. Alternatively, the B plate compensation layer 120 may be disposed on a top side (or an inner surface) of the lower substrate 101, and the lower polarizer 110 may be attached to the bottom side of the lower substrate 101.

The lower polarizer 110 will now be described in detail. The lower polarizer 110 has a transmissive axis in one direction, and the lower polarizer 110 blocks a component of light that is perpendicular to the transmissive axis. The lower polarizer 110 may be in a film form, the lower polarizer 110 may be formed by coating a polymer material, or the lower polarizer 110 may be formed with a plurality of metal lines or grids having fine gaps. The metal lines may have a structure in which the metal lines are arranged in one direction with a gap that is less than a wavelength of light.

In an exemplary embodiment, the B plate compensation layer 120 is provided on a top side of the lower polarizer 110. The B plate compensation layer 120 is an optical film having a biaxial characteristic, an in-plane retardation value (Rₒ) of the B plate compensation layer 120 may be in a range of about 50 nanometers (nm) to about 100 nm, and an out-of-plane retardation value (Rₜₕ) of the B plate compensation layer 120 may be in a range of about 80 nm to about 190 nm. In one exemplary embodiment, for example, the B plate compensation layer 120 has Rₒ of about 75 nm and Rₜₕ of about 135 nm.

In an exemplary embodiment, the upper panel 200 includes an upper substrate 201, an upper polarizer 210, and a C plate compensation layer 205. In such an embodiment, the C plate compensation layer 205 is disposed on a bottom side (or an inner surface) of the upper substrate 201, and the upper polarizer 210 is attached to a top side (or an outer surface) of the upper substrate 201.

In an exemplary embodiment, the upper substrate 201 includes a transparent substrate including or made of a transparent material such as glass. A color filter, a light blocking member and a common electrode may be further disposed inside the upper substrate 201 in addition to the C plate compensation layer 205.

In an exemplary embodiment, a plurality of openings corresponding to respective pixels may be defined through the light blocking member, and color filters may be provided in the respective openings. The color filters are configured as at least three types which respectively express three primary colors of light (e.g., red, green, and blue). A common electrode may be disposed below the light blocking member and the color filter, and the common electrode may be integrally formed as a single unitary unit to cover all of the pixels. The common electrode generates an electric field together with the pixel electrode of the lower panel 100.

The C plate compensation layer 205 may be coated with a predetermined thickness on the bottom side of the upper substrate 201, (also referred to as a coating C plate compensation layer). A retardation value of the coating C plate compensation layer may vary according to the coating thickness. As a result, the retardation value that may be provided by the coating C plate compensation layer 205 has no limits in comparison with the C plate attached in a film form. That is, the film-type C plate has a limit in the provided retardation value, but the coating C plate compensation layer has no such limit because it may freely generate the retardation value that may be provided by controlling the thickness. Further, the film-type C plate is attached to the outside of the upper substrate 201, so the light having passed through the liquid crystal layer 300 passes through a transparent substrate and another layer to compensate the light with a changed characteristic such as through refraction. However, when the coating C plate compensation layer 205 of which the inside is coated is used, it may be compensated before the light having passed through the liquid crystal layer 300 transmits through the transparent substrate and the other layer, thereby providing a compensation effect. The C plate compensation layer 205 may be formed when it is attached to the inside of the upper substrate 201, or it may be provided at a bottom side of the common electrode and nearest the liquid crystal layer 300. Further, it may be provided between the upper substrate 201 and the common electrode.

The C plate compensation layer 205 is a uniaxial compensation film, and it uses a negative-type C plate compensation layer in which the retardation value provided in a direction on a plane is the same as each other (nₓ=n_{y}) and the retardation value in a vertical direction is less than the retardation value in the direction on the plane (i.e., nₓ=n_{y}>n_{z}). Ideally, the retardation values provided in the direction on the plane are equal to each other (nₓ=n_{y}), however, in reality, there may be a predetermined difference between nₓ and n_{y} regarding the actually coated C plate compensation layer 205. The value of Rₜₕ (out-of-plane retardation value) of the C plate compensation layer 205 may be in a range of about 80 nm to about 260 nm, and it is desirable for the value of Rₒ (in-plane retardation value) to by 0, but the actually manufactured C plate compensation layer 205 may have a value that is near 0 because of the difference between nₓ and n_{y}. When the value of Rₒ of the C plate compensation layer 205 becomes high, display quality may be deteriorated, so the C plate compensation layer 205 with the value of Ro less than a predetermined value may be used depending on the display device. In an exemplary embodiment, the C plate compensation layer 205 with the value of Rₜₕ as 180 nm is used. In an exemplary embodiment, the values of Rₜₕ of the B plate compensation layer 120 and the C plate compensation layer 205 may satisfy the following condition or inequation 1.

180 nm≤Rₜₕ of B plate+Rₜₕ of C plate≤460 nm [Inequation 1]

Here, Rₜₕ of B plate denotes an out-of-plane retardation value (Rₜₕ) of the B plate compensation layer, and Rₜₕ of C plate denotes an out-of-plane retardation value (Rₜₕ₎) of the negative-type C plate compensation layer.

The C plate compensation layer 205 is formed by coating a retardation-providing material on an inside, arranging the retardation-providing material in a specific direction, and fixing the retardation-providing material. In an exemplary embodiment, for example, a liquid crystal material is coated to be rubbed or optically aligned in a specific direction, a heat treatment is applied to the coated liquid crystal material, and fix the same. In such an embodiment, the retardation value of the C plate compensation layer 205 may be controlled by controlling the thickness of the coated material.

The upper polarizer 210 is attached to the outer side (or surface) of the upper substrate 201.

The upper polarizer 210 has a transmissive axis in one direction, and the upper polarizer 210 blocks a component of the light that is perpendicular to the transmissive axis. In an exemplary embodiment, as shown in FIG. 1, the transmissive axis of the upper polarizer 210 may be perpendicular to the transmissive axis of the lower polarizer 110. As a result, when an electric field is not applied in the liquid crystal display using vertical alignment liquid crystal, light applied to the upper polarizer 210 is not transmitted to the outside and is blocked, thereby displaying a black image.

The upper polarizer 210 may be in a film form, the upper polarizer 210 may be formed by coating a polymer material, or the upper polarizer 210 may be formed with a plurality of metal lines or grids. The metal lines may have a structure in which the metal lines are arranged in one direction with a gap that is less than the wavelength of light.

The liquid crystal layer 300 is disposed between the lower panel 100 and the upper panel 200. The liquid crystal layer 300 may have a retardation in the range of about 240 nm to about 400 nm for the white light provided by the backlight unit 2000. In an exemplary embodiment, the liquid crystal layer 300 having a retardation of about 320 nm is used.

The liquid crystal layer 300 is vertically arranged when no electric field is applied, and the liquid crystal layer 300 rotates in a direction perpendicular to the lower panel 100 or the upper panel 200 when an electric field is applied.

Before the electric field is applied, liquid crystal molecules in the liquid crystal layer 300 are arranged in the vertical direction to provide the same retardation in a surface direction to the light proceeding in the vertical direction (the direction of the upper panel 200 on the lower panel 100). However, when the electric field is applied, the liquid crystal molecules rotate to be arranged in one direction from among surface directions. The electric field is formed in the vertical direction, so the component in the surface direction increases so that it may be arranged to be perpendicular thereto. As the electric field becomes stronger, the component in the surface direction further increases. Regarding the display panel 1000, the liquid crystal layer 300 may be divided into a plurality of domains, and the liquid crystal molecules in a same domain lie in a same direction. In one exemplary embodiment, for example, one pixel may have four domains, but not being limited thereto.

In a liquid crystal display device, when the display panel 1000 is seen on the side, the liquid crystal molecules are shown to be in a direction that is different from when the display panel 1000 is seen at the front (upper side), so luminance on the side may become different from luminance at the front.

Numerical ranges of the retardation values of the B plate compensation layer 120, the C plate compensation layer 205, and the liquid crystal layer 300 included in the description provided with reference to FIG. 1 are defined with respect to a lateral side and not the front side. That is, when the display panel 1000 displays a black image, the retardation value is set to show a black color to a specific position on the lateral side. That is, when viewed from a specific position on the lateral side, the light that is perpendicular to the lateral transmittance angle that is an angle formed by the transmissive axis of the upper polarizer with respect to the transmissive axis of the lower polarizer is set to be transmitted to the upper polarizer.

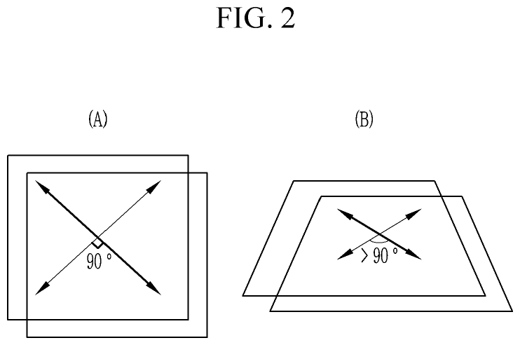

A difference between a case of viewing at the front and a case of viewing on the lateral side will now be described with reference to FIG. 2, and FIG. 2 shows a difference of an angle of a polarizer.

FIG. 2 shows transmissive axes of a polarizer on a front side and a lateral side.

FIG. 2 (A) shows transmissive axes when two polarizers are viewed from the top (front). As shown in FIG. 2 (A), the transmissive axes form an angle of about 90 degrees when the two polarizers are viewed at the top (the front of the display panel).

However, when viewed from the lateral side, the angle configured by the two transmissive axes is not about 90 degrees. That is, as shown in FIG. 2 (B), when the transmissive axis of the two polarizers is viewed in an oblique direction from the lateral side, it appears to have an angle that is greater than 90 degrees. This means the transmissive axis of the polarizer felt by the light that obliquely progresses to the lateral side. The angle between the transmissive axis of the upper polarizer viewed from the lateral side and the transmissive axis of the lower polarizer will be referred to as a lateral transmittance angle.

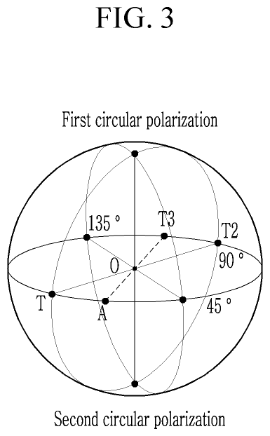

A spherical coordinate to be used will now be described with reference to FIG. 3 before the exemplary embodiment is described based upon the above-noted points.

FIG. 3 shows a spherical coordinate chart for a light polarization characteristic with respect to position in a liquid crystal display.

The spherical coordinate chart of FIG. 3 is also referred to as a Poincaré sphere, which describes all possible states of polarization with a sphere with a radius of 1. When the polarization characteristic of light is displayed with a 3×3 matrix, the matrix may be expressed by a vector. When the vector that shows the polarization characteristic of light is drawn in 3-dimensional coordinates, the polarization characteristic is expressed in the spherical coordinate chart as shown in FIG. 3.

FIG. 3 shows polarization of the transmissive axis of the lower polarizer 110 as T in the spherical coordinate chart. Here, the transmissive axis of the upper polarizer 210 forms an angle of about 90° with the transmissive axis of the lower polarizer 110, so polarization of the transmissive axis of the upper polarizer 210 is T2, which is opposite to the transmissive axis of the lower polarizer 110, considering that the polarization axis becomes the same axis when it rotates by 180°. From among a center horizontal side on the spherical coordinate chart, two points at which the line perpendicular to the line connecting T and T2 through a center (0) meets the spherical coordinate chart are points that form angles of 45° and 135° with respect to the transmissive axis of the lower polarizer 110. Further, two points at which the line extending in the vertical direction to the horizontal side (center horizontal side) including T, T2, 45°, and 135° from the center (0) meets the spherical coordinate chart mean circular polarizations (first circular polarization and second circular polarization), and one of the circular polarizations is left circular polarization while the other of circular polarizations is right circular polarization.

When viewed from the lateral side as described with reference to FIG. 2, the angle formed by the transmissive axes of the two polarizers is greater than 90°. The transmissive axis of the upper polarizer 210 seen by a viewer when viewed from the lateral side passes through 90° and is provided at T3, which is a value greater than 90°. T3 corresponds to the lateral transmittance angle. The exact point of T3 becomes different depending on the viewing positions or a position of the viewer, the point that leaks light the most may be set to be a reference, and one of regions with high lateral light leakage may be set to be a reference depending on exemplary embodiments. Descriptions to be provided below will be based on the lateral side 60°.

When the angle formed by the transmissive axes of two polarizers corresponds to T3 when viewed from a lateral side of a specific position (lateral side 60°), to prevent light from leaking from the lateral side of the corresponding specific position, light forming 90° for the polarization of T3 is desired to be input to the upper polarizer 210. This is the position A that is opposite T3 in the spherical coordinate chart of FIG. 3. Therefore, when light having the polarization of position A is provided to the upper polarizer 210, light progressing in an oblique direction has polarization that is perpendicular to the transmissive axis of the upper polarizer 210, thereby blocking the light and reducing luminance expressing a black color.

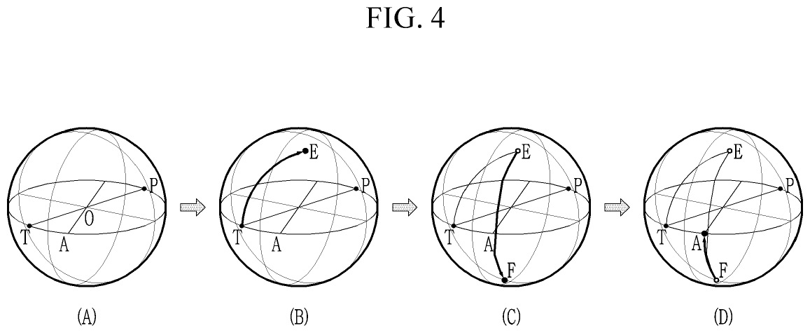

A change of a polarization characteristic according to an exemplary embodiment will now be described with reference to FIG. 4 in consideration of the above-noted point.

FIG. 4 sequentially shows changes of polarization of light according to an exemplary embodiment of FIG. 1.

FIG. 4 (A) shows polarization of light passed through a lower polarizer 110, FIG. 4 (B) shows polarization of light passed through a B plate compensation layer 120, FIG. 4 (C) shows polarization of light passed through a liquid crystal layer 300, and FIG. 4 (D) shows polarization of light passed through a negative-type C plate compensation layer 205.

First, white light provided by the backlight unit 2000 passes through the lower polarizer 110 to have linear polarization. A direction of the transmissive axis of the lower polarizer 110 is shown as T in the spherical coordinate chart (refer to FIG. 4 (A)).

Next, when the light passed through the lower polarizer 110 passes through the B plate compensation layer 120, polarization of light is changed to a position E. The position E may be changed according to a compensation characteristic of the B plate compensation layer 120, and it is one of oval polarizations. Referring to FIG. 4 (B), the B plate compensation layer 120 used in an exemplary embodiment uses Rₒ of about 75 nm and Rₜₕ of about 135 nm.

Next, when light passed through the B plate compensation layer 120 passes through the liquid crystal layer 300, polarization of the light is changed to the position F. The position F may also be changed according to the retardation characteristic of the liquid crystal layer 300, it is one of oval polarizations or an oval polarization in an opposite direction to the position E. Referring to FIG. 4 (C), in an exemplary embodiment, a material and a thickness for providing retardation of 320 nm is used for providing the liquid crystal layer.

Next, when the light passed through the liquid crystal layer 300 passes through the negative-type C plate compensation layer 205, it is changed to linear polarization of the position A. The position A is perpendicular to the transmissive axis of the upper polarizer 210 in the viewpoint on the lateral side, so the light is not allowed to pass through the upper polarizer 210. As a result, black is effectively expressed and no light leakage occurs. In an exemplary embodiment, the negative-type C plate compensation layer 205 with Rₜₕ of about 180 nm is used. The value of Rₒ of the C plate compensation layer 205 is a value that is substantially little and is close to 0.

In an exemplary embodiment, as described above, there may be no light leakage with reference to the point where light leaks the most, so even when the light leaks from the lateral side at other points, light leakage at the later side is substantially reduced. Accordingly, in such an embodiment, black luminance may be reduced for all directions, and the contrast ratios (CR) for all directions are improved.

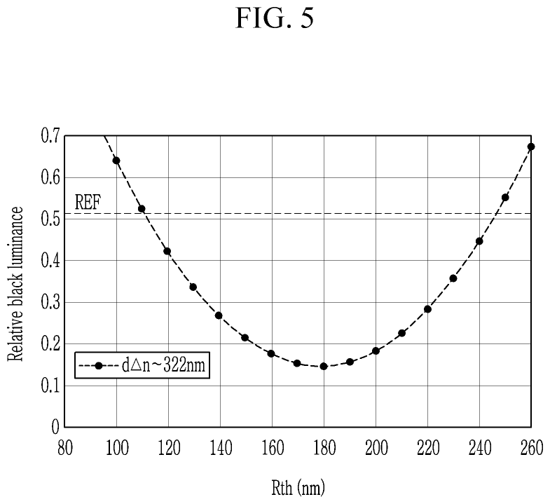

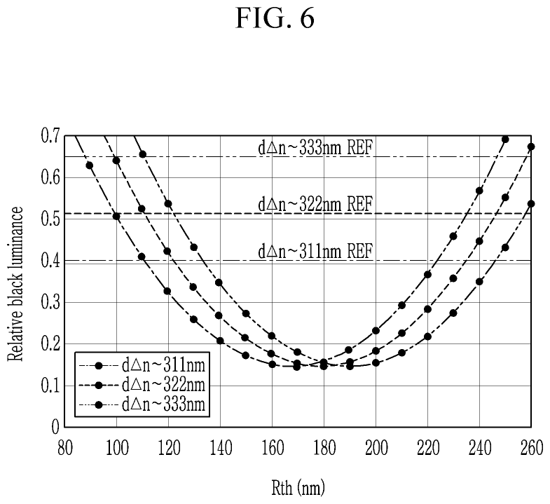

Luminance in the black is closely related to the contrast ratio (CR), so relative black luminance according to an exemplary embodiment will now be described with reference to FIG. 5 and FIG. 6.

FIG. 5 and FIG. 6 show graphs of relative black luminance for a value Rₜₕ of a compensation film.

Here, the black luminance for all directions is summed, the largest value is set to be 1, and a ratio of each black luminance with respect to the largest value is set to be the relative black luminance. Therefore, when the value has the least relative black luminance in FIG. 5 and FIG. 6, it means the least black luminance in all directions, and it indicates that the contrast ratios (CR) in all directions are improved the most.

First, FIG. 5 shows relative black luminance according to the value of Rₜₕ of the C plate compensation layer 205 in a case where the liquid crystal material with the retardation of 322 nm is used for the liquid crystal layer.

As shown in FIG. 5, when the value of Rₜₕ of the C plate compensation layer 205 is about 180 nm, minimum black luminance may be obtained. The angle between the transmissive axes of two polarizers is changed each time when viewed from various angles on the lateral side, so the C plate compensation layer 205 may have other values of Rₜₕ different from the value of Rₜₕ of the C plate compensation layer 205 in the case of the minimum black luminance. The C plate compensation layer may have the value of Rₜₕ of about 80 nm to about 260 nm, and in FIG. 5, to have improved relative black luminance compared to the reference value (REF). In one exemplary embodiment, for example, the value of Rₜₕ of the C plate compensation layer 205 may be in in a range of 110 nm to 250 nm. Here, the reference value (REF) corresponds to the case of using a specific B plate instead of the C plate compensation layer 205, and the B plate used in this case corresponds to the case in which the B plate with the value of Rₒ of 65 nm and the value of Rₜₕ of 250 nm is used.

However, the value of Rₜₕ of the C plate compensation layer 205 is changed depending on the retardation value of the liquid crystal layer included therein. A change of relative black luminance according to a change of a liquid crystal layer of the C plate compensation layer 205 will now be described with reference to FIG. 6.

In FIG. 6, liquid crystal materials having retardation values of 311 nm, 322 nm, and 333 nm are used for the liquid crystal layer of the C plate compensation layer 205. As shown with reference to FIG. 6, the value Rₜₕ of the C plate compensation layer 205 is found to have the minimum value around 180 nm, and the minimum value is provided in the range of 160 nm to 200 nm. Further, when the B plate used for the reference value (REF) of FIG. 5 is used instead of the C plate compensation layer 205, the reference value (REF) for each liquid crystal is set, which is shown with horizontal lines.

To have relative black luminance that is less than the maximum reference value (REF), the value of Rₜₕ of the C plate compensation layer 205 may be in a range of about 90 nm to about 260 nm, and to apply to all liquid crystal layers, it may be 80 nm to 260 nm. Further, to have relative black luminance that is less than the minimum value from among the reference value (REF), the value of Rₜₕ of the C plate compensation layer 205 may be in a range of about 110 nm to about 250 nm.

Referring to FIG. 5 and FIG. 6, the relative black luminance is provided with respect to the black luminance in all directions, Accordingly, FIGS. 5 and 6 shows in an exemplary embodiment, the black luminance in all directions reduces, and the contrast ratio (CR) in all directions increases.

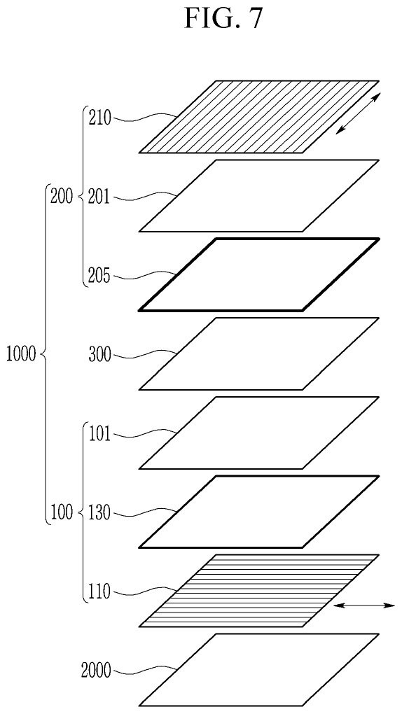

In the above, exemplary embodiments of the display panel 1000 using a negative-type C plate compensation layer and a B plate compensation layer has been described. Hereinafter, exemplary embodiments of a display panel 1000 using a negative-type C plate compensation layer and an A plate compensation layer will now be described with reference to FIG. 7.

FIG. 7 shows a schematic diagram of a liquid crystal display according to an alternative exemplary embodiment.

The liquid crystal display shown in FIG. 7 is substantially the same as the liquid crystal display shown in FIG. 1 except that the lower panel 100 includes an A plate compensation layer 130 rather than a B plate compensation layer 120.

The same or like elements shown in FIG. 7 have been labeled with the same reference characters as used above to describe the exemplary embodiments of the liquid crystal display shown in FIG. 1, and any repetitive detailed description thereof will hereinafter be omitted or simplified.

In an exemplary embodiment, as shown in FIG. 7, a lower panel 100 includes a lower substrate 101, an A plate compensation layer 130 attached to a bottom side thereof, and a lower polarizer 110. The A plate compensation layer 130 is on a top side of the lower polarizer 110, and on a bottom side of the lower substrate 101.

The A plate compensation layer 130 may be a film having an optically uniaxial characteristic, the A plate compensation layer 130 provides same retardation in one of surface directions (x, y directions) and in the vertical direction (z direction) as each other, and provides different retardation in the other of the surface directions (x, y direction). In an exemplary embodiment of the invention, the A plate compensation layer 130 may have an in-plane retardation value (Rₒ) in a range of about 70 nm to about 180 nm, and an out-of-plane retardation value (Rₜₕ) may be theoretically or ideally 0 nm. However, in realty, the value of Rₜₕ (out-of-plane retardation) of the actual A plate compensation layer 130 may be in a range of about 10 nm to about 90 nm. In an exemplary embodiment, the A plate compensation layer 130 having Ro of 125 nm is used.

In an exemplary embodiment, where the A plate compensation layer 130 is used as described above, the retardation characteristic of the C plate compensation layer 205 is changed as below.

In such an embodiment, the C plate compensation layer 205 is a uniaxial compensation film, retardation values provided in a direction on a plane are the same (nₓ=n_{y}) as each other, and the negative-type C plate compensation layer in which a retardation value in the vertical direction is less than the retardation value (nₓ=n_{y}>n_{z}) is used. Ideally, the retardation values provided in the direction on the plane are the same (nₓ=n_{y}), but nₓ and n_{y} of the actually coated C plate compensation layer 205 may be slightly different from each other. The value of Rₜₕ of the C plate compensation layer 205 may be in a range of about 90 nm to about 450 nm, and the value of Rₒ is determined by a difference between nₓ and n_{y} by definition. Accordingly, it is desirable for the difference between nₓ and n_{y} to be 0, but the actually manufactured C plate compensation layer 205 may have the difference between nₓ and n_{y} of a small value that approaches 0. When the value of Rₒ of the C plate compensation layer 205 becomes high, display quality may be deteriorated, so the C plate compensation layer 205 having Ro in a predetermined or allowable range may be used for the display device.

In an exemplary embodiment, the values of Rₜₕ of the A plate compensation layer 130 and the C plate compensation layer 205 may satisfy of the following condition or Inequation 2.

180 nm≤Rₜₕ of A plate+Rₜₕ of C plate≤460 nm [Inequation 2]

Here, Rₜₕ of the A plate denotes the out-of-plane retardation value (Rₜₕ) of the A plate compensation layer, and Rₜₕ of the negative-type C plate denotes the out-of-plane retardation value (Rₜₕ) of the C plate compensation layer. However, as described above, Rₜₕ of the A plate compensation layer 130 is theoretically 0, and Rₜₕ of the A plate compensation layer 130 has a value very close to 0, so the value of Rₜₕ of A plate+Rₜₕ of C plate in Inequation 2 may be substantially the same as the Rₜₕ value of the C plate compensation layer 205. Therefore, in such an embodiment, Rₜₕ of an actual or practical A plate compensation layer 130 may be in range of about 10 nm to 90 nm, and the Rₜₕ (of the C plate compensation layer 205 may be in a range of about 90 nm to about 450 nm.

In an exemplary embodiment of FIG. 7, the C plate compensation layer 205 is a compensation layer (coating C plate compensation layer) formed by coating with a predetermined thickness on an inner side (or surface) of the upper substrate 201. In such an embodiment, the coating C plate compensation layer may have high compensation effects compared to the case of attaching a compensation layer in a film form. In such an embodiment, the C plate compensation layer 205 may be attached to the inner side of the upper substrate 201, or may be disposed at the bottom side of the common electrode and nearest the liquid crystal layer 300. In an exemplary embodiment, the C plate compensation layer 205 may be disposed between the upper substrate 201 and the common electrode.

Numerical ranges of the retardation values of the A plate compensation layer 130, the C plate compensation layer 205 and the liquid crystal layer 300 included in the description provided with reference to FIG. 7 are provided with respect to the lateral side and not the front side. That is, when the display panel 1000 displays a black color, the retardation value is set to show black at a specific position on the lateral side. That is, when viewed from a specific position on the lateral side, the light that is perpendicular to the lateral transmittance angle (an angle formed by the transmissive axis of the upper polarizer with respect to the transmissive axis of the lower polarizer) is set to be transmitted to the upper polarizer.

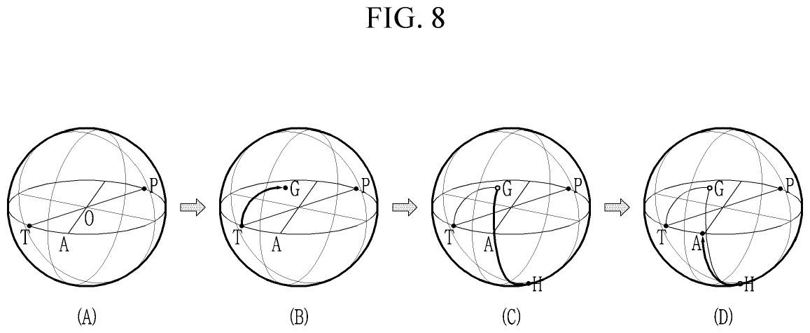

A change of polarization of the light passing through a display panel 1000 will now be described with reference to FIG. 8.

FIG. 8 sequentially shows changes of polarization of light according to an exemplary embodiment of FIG. 7.

First, as shown in FIG. 8 (A), white light provided by the backlight unit 2000 passes through the lower polarizer 110 to have linear polarization. The direction of the transmissive axis of the lower polarizer 110 is shown as T in the spherical coordinate chart.

As shown in FIG. 8 (B), when the light passed through the lower polarizer 110 passes through the A plate compensation layer 130, polarization of the light is changed to a position G. The position G may be varied by a compensation characteristic of the A plate compensation layer 130, and it is one of oval polarizations. In an exemplary embodiment, the A plate compensation layer 130 may have Rₒ of about 125 nm. The value of Rₜₕ of the A plate compensation layer 130 has a very small value substantially close to 0.

As shown in FIG. 8 (C), when light passed through the A plate compensation layer 130 passes through the negative-type C plate compensation layer 205, polarization of the light is changed to a position H. The position H may be changed according to the retardation characteristic of the C plate compensation layer 205, it is one of oval polarizations, which is an oval polarization in the opposite direction to the position G. In an exemplary embodiment, the negative-type C plate compensation layer 205 have Rₜₕ of 220 nm. The value Rₒ of the C plate compensation layer 205 has a very small value substantially close to 0.

As shown in FIG. 8 (D), when the light passed through the negative-type C plate compensation layer 205 passes through the liquid crystal layer 300, polarization of the light is changed to the position A. When viewed from the lateral side, the position A is the angle that is perpendicular to the transmissive axis of the upper polarizer 210, such that light is not allowed to pass through the upper polarizer 210. As a result, black is effectively expressed, and no light leakage occurs. In an exemplary embodiment, a material and a thickness used for the liquid crystal layer may be determined to have the retardation of 320 nm.

In the above, an exemplary embodiment using the A plate compensation layer 130 has been described with reference to FIG. 7.

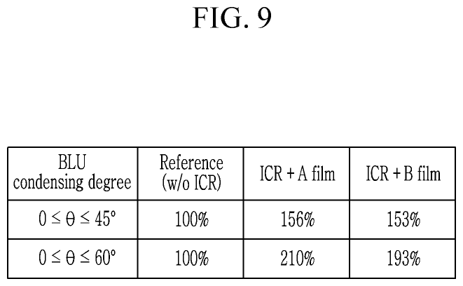

Characteristics of an exemplary embodiment of FIG. 1 and an exemplary embodiment of FIG. 7 will now be described with reference to FIG. 9.

FIG. 9 shows a table of contrast ratios (CR) at all sides according to an exemplary embodiment of FIG. 1 and an exemplary embodiment of FIG. 7.

In FIG. 9, two backlight units (BLU) are used to compare the contrast ratios (CR), the contrast ratio (CR) value according to a comparative example (Reference) is set to be 100%, and the contrast ratio (CR) values of an exemplary embodiment using an A plate (A film) and an exemplary embodiment using a B plate (B film) are shown. The contrast ratio (CR) values herein indicate the contrast ratio (CR) values in all directions.

As shown in FIG. 9, when a backlight unit (BLU) for inputting light with an angle of 0 to 45° with respect to the vertical direction is used, an exemplary embodiment using the A plate (A film) has the contrast ratio (CR) value of 156%, and an exemplary embodiment using the B plate (B film) has the contrast ratio (CR) value of 153%.

When a backlight unit (BLU) for inputting light with an angle of 0 to 60° with respect to the vertical direction is used, an exemplary embodiment using the A plate (A film) has the contrast ratio (CR) value of 210%, and an exemplary embodiment using the B plate (B film) has the contrast ratio (CR) value of 193%.

As shown in FIG. 9, when the light is set to be prevented from leaking to the A plate or the B plate together with the negative C plate with respect to the lateral transmitting angle viewed from the lateral side, the contrast ratios (CR) in all directions are improved by about 1.5 times to about 2 times.

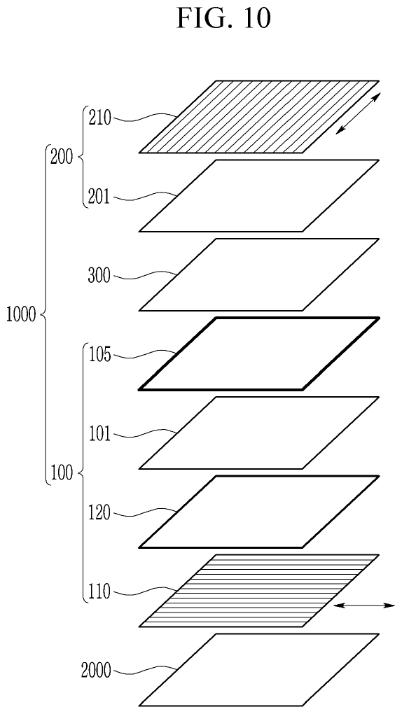

Another alternative exemplary embodiment of a liquid crystal display will now be described with reference to FIG. 10.

FIG. 10 shows a schematic diagram of a liquid crystal display according to another alternative exemplary embodiment.

The liquid crystal display shown in FIG. 10 is substantially the same as the liquid crystal display shown in FIG. 1 except that a negative-type C plate compensation layer 105 is further included in the lower panel 100.

The same or like elements shown in FIG. 10 have been labeled with the same reference characters as used above to describe the exemplary embodiments of the liquid crystal display shown in FIG. 1, and any repetitive detailed description thereof will hereinafter be omitted or simplified

In such an embodiment, the upper panel 200 includes an upper substrate 201 and an upper polarizer 210, and the lower panel 100 includes a lower substrate 101, a B plate compensation layer 120 attached to a bottom side of the lower substrate 101, a lower polarizer 110, and a C plate compensation layer 105 disposed on an inner side of the lower substrate 101.

In such an embodiment, the C plate compensation layer 105 may be attached to a top surface of an inner surface of the lower substrate 101, or the C plate compensation layer 105 may be disposed on the TFT and the pixel electrode. In an exemplary embodiment, the C plate compensation layer 105 may be disposed in the middle of a layer on which the TFT and the pixel electrode are disposed.

The retardation values of the B plate compensation layer 120, the liquid crystal layer 300 and the C plate compensation layer 105 included in an exemplary embodiment of FIG. 10 correspond to the retardation values described with reference to FIG. 1.

In such an embodiment as described above with reference to FIG. 1, the B plate compensation layer 120 provided at the top of the lower polarizer 110 is a film with an optically biaxial characteristic having an in-plane retardation value (Rₒ) in a range of about 50 nm to about 100 nm, and an out-of-plane retardation value (Rₜₕ) in a range of about 80 nm to about 190 nm. In an exemplary embodiment, the B plate compensation layer 120 may have Rₒ of 75 nm and Rₜₕ of 135 nm.

The C plate compensation layer 105 provided inside the lower substrate 101 is a coating C plate compensation layer, and the retardation value thereof is changed according to the coating thickness. Further, Rₜₕ value of the C plate compensation layer 105 may be in a range of about 80 nm to about 260 nm, and Rₒ value thereof is determined by a difference between nₓ and n_{y} by definition, so ideally, Rₒ value thereof is 0. However, the actually manufactured C plate compensation layer 105 may have a small value close to 0. When the Ro value of the C plate compensation layer 105 increases, display quality may be deteriorated, so the C plate compensation layer 105 having Ro in a predetermined or allowable range may be used for the display device. In an exemplary embodiment, the C plate compensation layer 105 may have the Rₜₕ value of 180 nm. In an exemplary embodiment, the values of Rₜₕ of the B plate compensation layer 120 and the C plate compensation layer 105 may satisfy the following condition or Inequation 1.

180 nm≤Rₜₕ of B plate+Rₜₕ of C plate≤460 nm [Inequation 1]

In such an embodiment, the liquid crystal layer 300 provided between the lower panel 100 and the upper panel 200 may provide retardation in a range of about 240 nm to about 400 nm for the white light provided by the backlight unit 2000. In one exemplary embodiment, for example, the liquid crystal layer 300 having retardation of 320 nm is used.

The numerical range of the retardation values of the B plate compensation layer 120, the C plate compensation layer 205 and the liquid crystal layer 300 included in the description of FIG. 10 are based on the lateral side and not the front side. That is, when the display panel 1000 displays a black color, the retardation value is set so that black may be visible from a specific position on the lateral side. That is, when viewed from a specific position on the lateral side, the light that is perpendicular to the lateral transmittance angle (an angle formed by the transmissive axis of the upper polarizer with respect to the transmissive axis of the lower polarizer) is set to be transmitted to the upper polarizer.

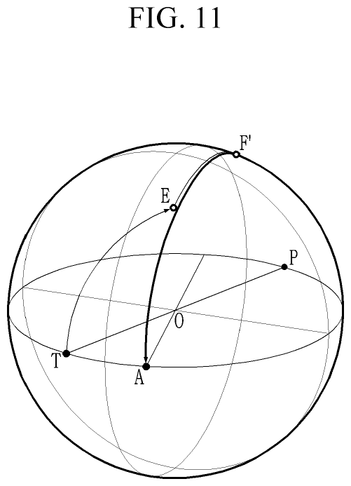

A change of polarization of light in an exemplary embodiment described with reference to FIG. 10 for forming the C plate compensation layer 105 on the lower panel 100 will now be described with reference to FIG. 11.

FIG. 11 shows changes of polarization of light according to an exemplary embodiment of FIG. 10.

FIG. 11 shows the change of the polarization characteristic by use of arrows on one spherical coordinate chart, differing from FIG. 4.

First, white light provided by the backlight unit 2000 passes through the lower polarizer 110 to have linear polarization. The direction of the transmissive axis of the lower polarizer 110 is shown as T on the spherical coordinate chart.

When the light further passes through the B plate compensation layer 120, polarization of the light is changed to a position E. The position E may be changed according to the compensation characteristic of the B plate compensation layer 120, and it is one of oval polarizations. The B plate compensation layer 120 with the value Rₒ of 75 nm and the value Rₜₕ of 135 nm is used in the exemplary embodiment.

When the light further passes through the negative-type C plate compensation layer 105, polarization of the light is changed to a position F′. The position F′ may be changed according to the retardation characteristic of the C plate compensation layer 105, it is one of oval polarizations, or an oval polarization in the same direction as the position E. In an exemplary embodiment, the negative-type C plate compensation layer 205 having Rₜₕ value of 180 nm is used. The Rₒ value of the C plate compensation layer 205 is a very small value close to 0.

When the light further passes through the liquid crystal layer 300, polarization of the light is changed to the position A. When viewed from the lateral side, the position A is the angle that is perpendicular to the transmissive axis of the upper polarizer 210, so the light passed through the liquid crystal layer 300 is not allowed to pass through the upper polarizer 210. As a result, a black color is effectively displayed, and no light leakage occurs. In an exemplary embodiment, a material and a thickness of the liquid crystal layer is determined to have the retardation of 320 nm.

Referring to FIG. 11, an exemplary embodiment of FIG. 10 and an exemplary embodiment of FIG. 1 provide light that is perpendicular to the lateral transmittance angle to the upper polarizer 210. As a result, an exemplary embodiment of FIG. 10 improves the contrast ratio (CR) in all directions as in an exemplary embodiment of FIG. 1.

In such an embodiment, the contrast ratio (CR) is improved in all directions in a like manner regardless of whether the C plate compensation layer is provided on the upper panel 200 or the lower panel 100.

Accordingly, in an exemplary embodiment where the A plate compensation layer is used instead of the B plate compensation layer, the C plate compensation layer may be provided to the lower panel 100.

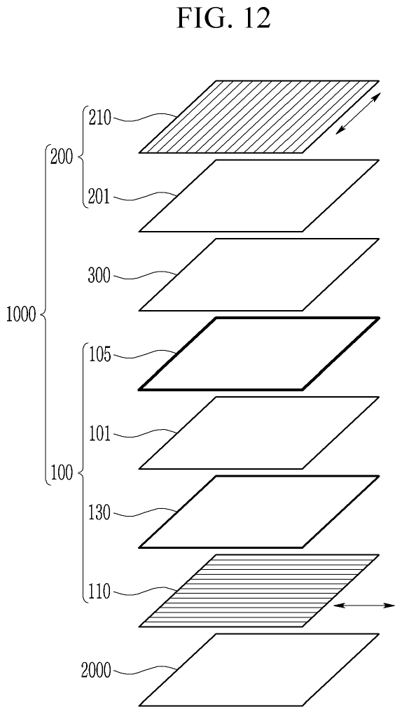

Another alternative exemplary embodiment will now be described with reference to FIG. 12.

FIG. 12 shows a schematic diagram of a liquid crystal display according to another alternative exemplary embodiment.

The liquid crystal display shown in FIG. 12 is substantially the same as the liquid crystal display shown in FIG. 7 except that the C plate compensation layer 105 is included in the lower panel 100.

The same or like elements shown in FIG. 12 have been labeled with the same reference characters as used above to describe the exemplary embodiments of the liquid crystal display shown in FIG. 7, and any repetitive detailed description thereof will hereinafter be omitted or simplified.

In such an embodiment, the upper panel 200 includes an upper substrate 201 and an upper polarizer 210, and the lower panel 100 includes a lower substrate 101, an A plate compensation layer 130 attached to the bottom side of the lower substrate 101, a lower polarizer 110, and a C plate compensation layer 105 disposed on an inner side of the lower substrate 101.

The retardation values of the A plate compensation layer 130, the liquid crystal layer 300 and the C plate compensation layer 105 included in an exemplary embodiment of FIG. 12 correspond to the retardation values described above with reference to FIG. 7.

In such an embodiment, the A plate compensation layer 130 is a film with an optically uniaxial characteristic, having a same retardation in one of the surface directions (x, y direction) and the vertical direction (z direction) as each other, and having a different retardation in the other of the surface directions (x, y direction). In an exemplary embodiment of the invention, the A plate compensation layer 130 may have the in-plane retardation value (Rₒ) in a range of about 70 nm to about 180 nm, and the out-of-plane retardation value (Rₜₕ) may be theoretically 0 nm. However, in reality, the Rₜₕ value of the actual A plate compensation layer 130 may be in a range of about 10 nm to about 90 nm. In the exemplary embodiment, the A plate compensation layer 130 with the value Rₒ of 125 nm is used.

The C plate compensation layer 105 provided inside the lower substrate 101 is a coating C plate compensation layer, and the retardation value provided to the transmitting light is changed according to the coating thickness.

The C plate compensation layer 105 is a uniaxial compensation film, the retardation values provided in the direction on the plane are the same (nₓ=n_{y}), and the negative-type C plate compensation layer in which the retardation value in the vertical direction is less than the retardation value (nₓ=n_{y}>n_{z}) on the plane is used.

The values Rₜₕ of the A plate compensation layer 130 and the C plate compensation layer 105 usable in the exemplary embodiment may satisfy the following condition or Inequation 2.

180 nm≤Rₜₕ of A plate+Rₜₕ of C plate≤460 nm [Inequation 2]

Here, Rₜₕ of A plate denotes the out-of-plane retardation value (Rₜₕ) of the A plate compensation layer, and Rₜₕ of C plate denotes the out-of-plane retardation value (Rₜₕ) of the negative-type C plate compensation layer.

However, as described above, the Rₜₕ value of the A plate compensation layer 130 is theoretically 0, but an actual A plate compensation layer may have a value close to 0, so Rₜₕ of A plate+Rₜₕ of C plate of Inequation 2 may be determined mostly by the Rₜₕ value of the C plate compensation layer 105. Practically, as described above with reference to FIG. 7, the Rₜₕ value of the C plate compensation layer 205 may be in a range of about 90 nm to about 450 nm.

In such an embodiment, the C plate compensation layer 105 may be attached to the inner side of the lower substrate 101, or the C plate compensation layer 105 may be disposed on the TFT and the pixel electrode. Alternatively, the C plate compensation layer 105 may be disposed in the middle of the layer on which the TFT and the pixel electrode are disposed.

The numerical range of the retardation values of the B plate compensation layer 120 the C plate compensation layer 205, and the liquid crystal layer 300 included in the description of FIG. 12 is based on the lateral side and not the front side. That is, when the display panel 1000 displays black, the retardation value is set so that black may be seen at a specific position of the lateral side. That is, when viewed from a specific position of the lateral side, the light that is perpendicular to the lateral transmittance angle (the angle of the transmissive axis of the upper polarizer with respect to the transmissive axis of the lower polarizer) is set to be transmitted to the upper polarizer.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a display panel including an upper panel, a lower panel, and a liquid crystal layer disposed between the upper panel and the lower panel; and
a backlight unit which provides light to the display panel,
wherein
the upper panel includes an upper polarizer,
the lower panel includes a B plate compensation layer and a lower polarizer,
one of the upper panel and the lower panel further includes a negative-type C plate compensation layer, and
retardation values of the liquid crystal layer, the B plate compensation layer and the negative-type C plate compensation layer are set to allow light perpendicular to a lateral transmittance angle, which is an angle of a transmissive axis of the upper polarizer with respect to a transmissive axis of the lower polarizer when viewed from a specific position at a lateral side, to be transmitted to the upper polarizer when displaying a black color.

2. The liquid crystal display of claim 1, wherein
the negative-type C plate compensation layer has a an out-of-plane retardation value (Rₜₕ) in a range of about 80 nanometers to about 260 nanometers.

3. The liquid crystal display of claim 2, wherein
the B plate compensation layer has an optically biaxial characteristic,
an in-plane retardation value (Rₒ) of the B plate compensation layer is in a range of 50 nanometers to 100 nanometers, and
an out-of-plane retardation value (Rₜₕ) of the B plate compensation layer is in a range of about 80 nanometers to about 190 nanometers.

4. The liquid crystal display of claim 3, wherein
the liquid crystal layer includes liquid crystal molecules,
the liquid crystal molecules are vertically aligned when an electric field is not applied thereto, and
the liquid crystal layer provides retardation in a range of about 240 nanometers to about 400 nanometers to the light provided by the backlight unit.

5. The liquid crystal display of claim 4, wherein
the negative-type C plate compensation layer has the out-of-plane retardation value (Rₜₕ) of about 180 nanometers,
the B plate compensation layer has an in-plane retardation value(Rₒ) of about 75 nanometers and the out-of-plane retardation value (Rₜₕ) of about 135 nanometers, and
the liquid crystal layer provides retardation of about 320 nanometers to the light provided by the backlight unit.

6. The liquid crystal display of claim 1, wherein
the out-of-plane retardation value (Rₜₕ) of the negative-type C plate compensation layer and the out-of-plane retardation value (Rₜₕ) of the B plate compensation layer satisfy the following condition:
180 nanometers≤Rₜₕ of B plate+Rₜₕ of C plate≤460 nanometers,
wherein
Rₜₕ of B plate denotes the out-of-plane retardation value (Rₜₕ) of the B plate compensation layer, and
Rₜₕ of C plate denotes the out-of-plane retardation value (Rₜₕ) of the negative-type C plate compensation layer.

7. The liquid crystal display of claim 1, wherein
the specific position of the lateral side is in a region where high lateral light leakage occurrence is observed.

8. The liquid crystal display of claim 1, wherein
the upper panel includes the negative-type C plate compensation layer, and
the negative-type C plate compensation layer is disposed on an inner surface of the upper panel.

9. The liquid crystal display of claim 1, wherein
the lower panel includes the negative-type C plate compensation layer, and
the negative-type C plate compensation layer is disposed on an inner surface of the lower panel.

10. The liquid crystal display of claim 1, wherein
the negative-type C plate compensation layer is formed by coating a material for providing retardation.

11. A liquid crystal display comprising:
a display panel including an upper panel, a lower panel, and a liquid crystal layer disposed between the upper panel and the lower panel; and
a backlight unit which provides light to the display panel,
wherein
the upper panel includes an upper polarizer,
the lower panel includes an A plate compensation layer and a lower polarizer,
one of the upper panel and the lower panel further includes a negative-type C plate compensation layer, and
retardation values provided by the liquid crystal layer, the A plate compensation layer and the negative-type C plate compensation layer are set to allow light perpendicular to a lateral transmittance angle, which is an angle of a transmissive axis of the upper polarizer with respect to a transmissive axis of the lower polarizer when viewed form a specific position on a lateral side, to be transmitted to the upper polarizer when displaying a black color.

12. The liquid crystal display of claim 11, wherein
the negative-type C plate compensation layer has an out-of-plane retardation value (Rₜₕ) in a range of about 90 nanometers to about 450 nanometers.

13. The liquid crystal display of claim 12, wherein
the A plate compensation layer has an optically uniaxial characteristic, and
an in-plane retardation value (Rₒ) of the A plate compensation layer is in a range of about 70 nanometers to about 180 nanometers.

14. The liquid crystal display of claim 13, wherein
the liquid crystal layer includes liquid crystal molecules,
the liquid crystal molecules are vertically arranged when an electric field is not applied thereto, and
the liquid crystal layer provides retardation in a range of about 240 nanometers to about 400 nanometers to the light provided by the backlight unit.

15. The liquid crystal display of claim 14, wherein
the A plate compensation layer has the in-plane retardation value (Rₒ) of about 125 nanometers, and
the liquid crystal layer provides retardation of about 320 nanometers to the light provided by the backlight unit.

16. The liquid crystal display of claim 11, wherein
an out-of-plane retardation value (Rₜₕ) of the negative-type C plate compensation layer and an out-of-plane retardation value (Rₜₕ) of the A plate compensation layer satisfy the following condition:
180 nanometers≤Rₜₕ of A plate+Rₜₕ of C plate≤460 nanometers,
wherein
Rₜₕ of A plate denotes the out-of-plane retardation value (Rₜₕ) of the A plate compensation layer, and
Rₜₕ of C plate denotes the out-of-plane retardation value (Rₜₕ) of the negative-type C plate compensation layer.

17. The liquid crystal display of claim 11, wherein
the specific position of the lateral side is in a region where high light leakage occurrence is observed.

18. The liquid crystal display of claim 11, wherein
the upper panel includes the negative-type C plate compensation layer, and
the negative-type C plate compensation layer is disposed on an inner surface the upper panel.

19. The liquid crystal display of claim 11, wherein
the lower panel includes the negative-type C plate compensation layer, and
the negative-type C plate compensation layer is disposed on an inner surface the lower panel.

20. The liquid crystal display of claim 11, wherein
the negative-type C plate compensation layer is formed by coating a material for providing retardation.
